(19) United States
(12) Patent Application Publication
(10) Pub. No.: US 2021/0156390 A1
(43) Pub. Date: May 27, 2021

(54) CONTACTING SEAL ARRANGEMENT FOR LOW AND HIGH PRESSURE APPLICATIONS

(71) Applicant: Westinghouse Electric Company LLC, Cranberry Township, PA (US)

(72) Inventors: Arnaud Milan, Coraopolis, PA (US); Michael A. LaPresti, Greensburg, PA (US); Bruce A. Howard, Monroeville, PA (US); Brandon H. Bruner, Prospect, PA (US); Randall J. Marchelletta, Pittsburgh, PA (US)

(73) Assignee: Westinghouse Electric Company LLC, Cranberry Township, PA (US)

(21) Appl. No.: 16/697,351

(22) Filed: Nov. 27, 2019

(51) Int. Cl. F04D 29/08

(52) U.S. Cl. CPC F04D 29/08

(57) ABSTRACT

A runner assembly for mounting to, and rotating with, a pump shaft of a pump includes a support member to be fixed to the pump shaft; a seal face ring positioned on, and mounted to the support member by a support shroud coupled to the support member; and an outer O-ring positioned in an upward and radially outward facing notch defined in a top portion of the support member. The outer O-ring forms a static sealed joint between the top of the support member and the bottom of the seal face ring.

### FIELD OF THE INVENTION

The disclosed concept is directed to seal arrangements for pumps and, more particularly, to seal arrangements for pumps used in connection with nuclear reactors.

### BACKGROUND

Commercial pressurized water reactors often employ face rubbing mechanical face seals between the motor and hydraulic sections of the reactor coolant pumps, for low and middle ranges of pressures. Such seals are designed to permit a controlled and stable volume of leakage from the primary system while experiencing minimal wear. Leakage through the seal is dependent upon the face geometry and mechanical design as well as the thermodynamic state of the sealed fluid. Nuclear reactor plant operators seek to maintain a maximal volumetric leakage rate of 0.05 gallons per minute through the reactor coolant pump low pressure seals (also known as Number 2 seals). This amount of leakage is large enough to provide for adequate lubrication of the seal faces; however, it is small enough to be negligible in the plant balance of flows.

The volumetric leakage rate through the seal and the wear of the seal interface components are determined principally by the as-manufactured dimensions of the seal's components, contact friction forces at the interfaces of adjoining components, and mechanical and thermoelastic deformation resulting from the operating temperature and pressure of the sealed fluid. Since plant operators desire to maintain a stable leakage rate through the reactor coolant pump seal, it is necessary for the design of the seal to be optimized such that manufacturing tolerances, contact friction forces, and mechanical and thermoelastic deformation exert the minimum possible influence on the seal leakage rate while maintaining a low wear rate.

### SUMMARY OF THE INVENTION

Embodiments of the disclosed concept improve upon conventional seal arrangements. As one aspect of the disclosed concept, a runner assembly for mounting to, and rotating with, a pump shaft of a pump is provided. The runner assembly comprises: a support member structured to be fixed to the pump shaft; a seal face ring positioned on, and mounted to the support member by a support shroud coupled to the support member; and an outer O-ring positioned in an upward and radially outward facing notch defined in a top portion of the support member, the outer O-ring forming a static sealed joint between the top of the support member and the bottom of the seal face ring.

The seal face ring may be formed from a ceramic material. The seal face ring may comprise a shoulder formed in a radially outward portion thereof, the support shroud may comprise an overhang formed in a radially inward portion thereof, and the shoulder and the overhang may radially overlap. The seal face ring may be fixed relative to the support member via a number of drive pins such that there is no relative rotation between the pump shaft, the support member, and the seal face ring.

The runner assembly may further comprise a number of anti-rotation pins for fixing the support member to the pump shaft.

As another aspect of the invention, a sealing arrangement for use with a pump having a pump housing which terminates at one end in a seal housing and a pump shaft is provided. The sealing arrangement comprises: a lower annular runner assembly structured to be mounted to the pump shaft for rotation therewith, the runner assembly comprising: a support member structured to be fixed to the pump shaft, a seal face ring positioned on, and mounted to the support member by a support shroud coupled to the support member, and an outer O-ring positioned in an upward and radially outward facing notch defined in a top portion of the support member, the outer O-ring forming a static sealed joint between the top of the support member and the bottom of the seal face ring. The sealing arrangement further comprises an upper annular seal assembly structured to be stationarily mounted within the seal housing, the seal assembly comprising: an upper annular ring sealing face member positioned for sealing with the seal face ring, the sealing face member mounted in an upper annular support member structured to be coupled to the seal housing via a number of anti-rotation pins so as to prevent rotational movement of the assembly relative to the seal housing but allow translatory movement of the seal assembly along the pump shaft toward and away from the runner assembly.

The seal face ring may be formed from a ceramic material. The seal face ring may comprise a shoulder formed in a radially outward portion thereof, the support shroud may comprise an overhang formed in a radially inward portion thereof, and the shoulder and the overhang may radially overlap. The seal face ring may be fixed relative to the support member via a number of drive pins such that there is no relative rotation between the pump shaft, the support member, and the seal face ring.

As yet a further aspect of the present invention a pump is provided. The pump comprises: a pump housing which terminates at one end in a seal housing; a pump shaft extending centrally within the pump housing and being sealingly and rotatably mounted within the seal housing; and a sealing arrangement provided about the pump shaft and within the pump housing. The sealing arrangement comprises a lower annular runner assembly mounted to the pump shaft for rotation therewith. The runner assembly comprises: a support member fixed to the pump shaft, a seal face ring positioned on, and mounted to the support member by a support shroud coupled to the support member, and an outer O-ring positioned in an upward and radially outward facing notch defined in a top portion of the support member. The outer O-ring forms a static sealed joint between the top of the support member and the bottom of the seal face ring. The sealing arrangement further comprises an upper annular seal assembly stationarily mounted within the seal housing. The seal assembly comprises an upper annular ring sealing face member positioned for sealing with the seal face ring, the sealing face member mounted in an upper annular support member coupled to the seal housing via a number of anti-rotation pins so as to prevent rotational movement of the assembly relative to the seal housing but allow translatory movement of the seal assembly along the pump shaft toward and away from the runner assembly.

The seal face ring may be formed from a ceramic material. The seal face ring may comprise a shoulder formed in a radially outward portion thereof, the support shroud may comprise an overhang formed in a radially inward portion thereof, and the shoulder and the overhang may radially overlap. The seal face ring may be fixed relative to the support member via a number of drive pins such that there is no relative rotation between the pump shaft, the support member, and the seal face ring.

A first end of the pump shaft may be connected to an impeller and an opposite second end may be connected to an electric motor, and the impeller may be positioned within an interior of the pump housing.

The support member may be fixed to the pump shaft via a number of anti-rotation pins.

The pump may further comprise a biasing member positioned to bias the seal assembly toward the runner assembly, and thus the sealing face member into contact with the seal face ring.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

A full understanding of the invention can be gained from the following description of the preferred embodiments when read in conjunction with the accompanying drawings in which:

FIG. 1 is a schematic representation of one cooling loop of a conventional nuclear reactor coolant system which includes a steam generator and a reactor coolant pump connected in series in a closed coolant flow circuit with a reactor core;

FIG. 2 is an axial view of a shaft seal arrangement of a coolant pump in accordance with one example embodiment of the present invention;

FIG. 3 is a sectional view of the arrangement of FIG. 2 taken along line 3-3 of FIG. 2; and

FIG. 4 is a detail view of the portion of FIG. 3 indicated in FIG. 3.

### DESCRIPTION OF THE PREFERRED EMBODIMENTS

The present invention will now be described more fully hereinafter with reference to the accompanying drawings, in which examples of the invention are shown. The invention may, however, be embodied in many different forms and should not be construed as limited to the examples set forth herein. Rather, these examples are provided so that this disclosure will be thorough and complete, and will fully convey the scope of the invention to those skilled in the art. Like numbers refer to like elements throughout.

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein. As used herein, the term “number” shall mean one or an integer greater than one (i.e., a plurality).

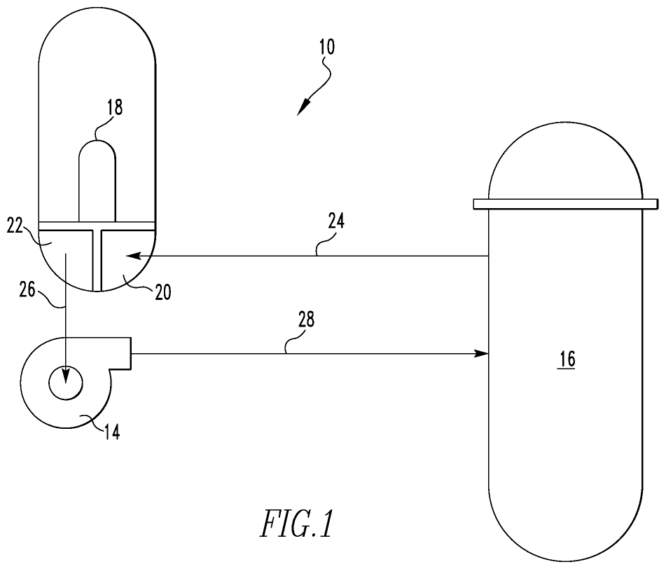

Referring now to the drawings, and particularly to FIG. 1, there is shown a schematic representation of one of a plurality of cooling loops 10 of a conventional nuclear reactor coolant system. The cooling loop 10 includes a steam generator 12 and a reactor coolant pump 14 serially connected in a closed coolant flow circuit with a nuclear reactor core 16. The steam generator 12 includes primary tubes 18 communicating with inlet and outlet plenums 20,22 of the generator. The inlet plenum 20 of the steam generator 12 is connected in flow communication with the outlet of the reactor core 16 for receiving hot coolant therefrom along flow path 24 of the closed flow circuit. The outlet plenum 22 of the steam generator 12 is connected in flow communication with an inlet suction side of the reactor coolant pump 14 along flow path 26 of the closed flow circuit. The outlet pressure side of the reactor coolant pump 14 is connected in flow communication with the inlet of the reactor core 16 for feeding cold coolant thereto along flow path 28 of the closed flow circuit.

In brief, the coolant pump 14 pumps the coolant under high pressure about the closed flow circuit. Particularly, hot coolant emanating from the reactor core 16 is conducted to the inlet plenum 20 of the steam generator 12 and to the primary tubes 18 in communication therewith. While in the primary tubes 18, the hot coolant flows in heat exchange relationship with cool feedwater supplied to the steam generator 12 via conventional means (not shown). The feedwater is heated and portions thereof changed to steam for use in driving a turbine generator (not shown). The coolant, whose temperature has been reduced by the heat exchange, is then recirculated to the reactor core 16 via the coolant pump 14.

The reactor coolant pump 14 must be capable of moving large volumes of reactor coolant at high temperatures and pressures about the closed flow circuit. Although, the temperature of the coolant flowing from the steam generator 12 to the pump 14 after heat exchange has been cooled substantially below the temperature of the coolant flowing to the steam generator 12 from the reactor core 16 before heat exchange, its temperature is still relatively high, being typically about 550 degrees F. The coolant pressure produced by the pump is typically about 2500 psi.

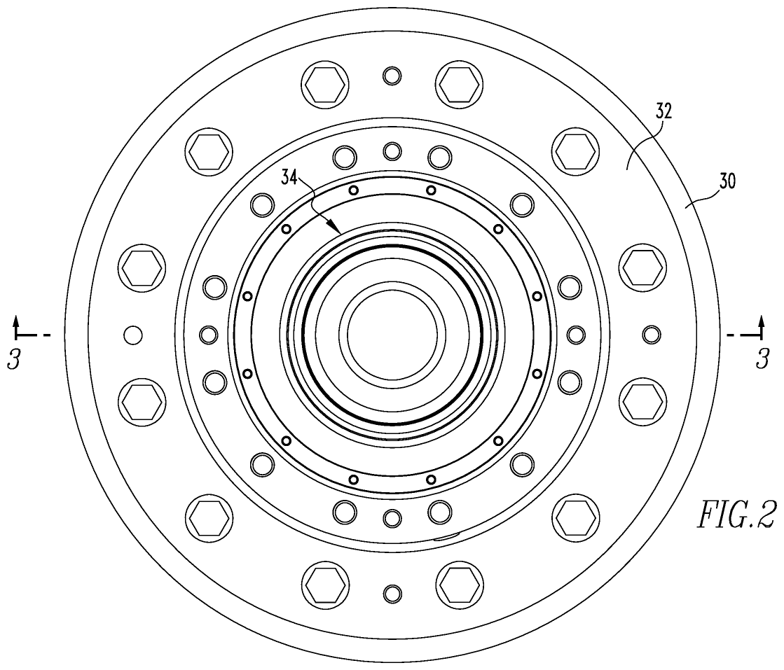

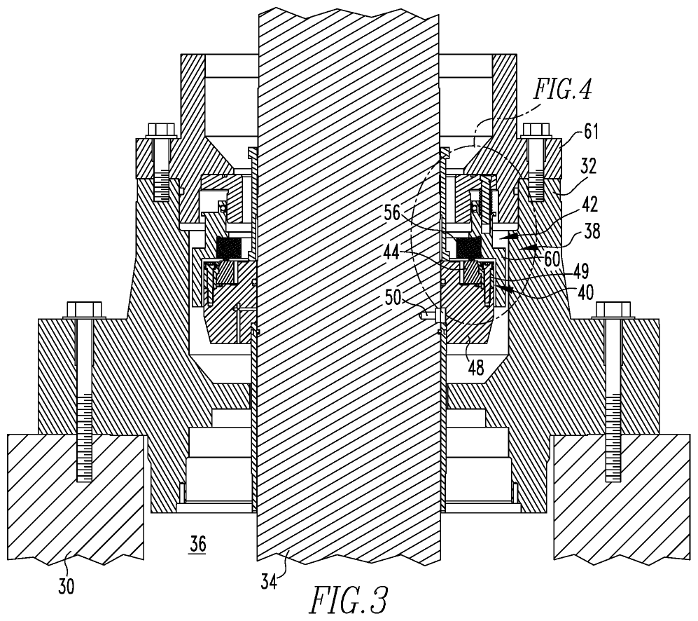

Referring now to FIGS. 2 and 3, reactor coolant pump 14 generally includes a pump housing 30 which terminates at one end in a seal housing 32. Pump 14 also includes a pump shaft 34 extending centrally within pump housing 30 and being sealingly and rotatably mounted within seal housing 32. Although not shown, the bottom portion of pump shaft 34 is connected to an impeller, while a top portion thereof is connected to a high-horsepower, induction-type electric motor. When the motor rotates shaft 34, the impeller within the interior 36 of pump housing 30 circulates the coolant flowing through pump housing 30 at pressures from ambient to approximately 2500 psi cover gas. This pressurized coolant applies an upwardly directed, hydrostatic load upon the shaft 34 since the outer portion of seal housing 32 is surrounded by the ambient atmosphere.

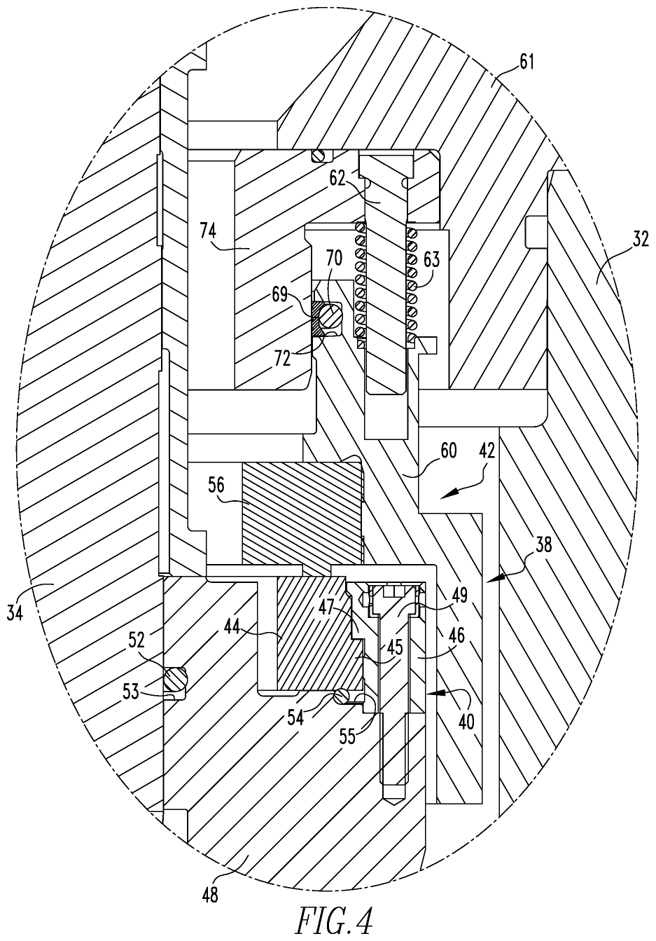

In order that pump shaft 34 might rotate freely within seal housing 32 while maintaining the pressure boundary between pump housing interior 36 and the outside of seal housing 32, a sealing arrangement 38 is provided about pump shaft 34 and within pump housing 30. As more clearly seen in the detail view of FIG. 4, sealing arrangement 38 generally includes a lower annular runner assembly 40 which is mounted to pump shaft 34 for rotation therewith and an upper annular seal assembly 42 which is stationarily mounted within seal housing 32. Runner assembly 40 includes a seal face ring 44 having a shoulder 45 formed in a radially outward portion thereof. Seal face ring 44 is mounted by a support shroud 46, having an overhang 47 (that radially overlaps shoulder 45) formed in a radially inward portion thereof, to a lower annular runner base or support member 48 which, in turn, is keyed to pump shaft 34 by anti-rotation pins 50 (FIG. 3). Seal face ring 44 is likewise fixed relative to support member 48 via one or more drive pins (not shown) such that there is no relative rotation between pump shaft 34, support member 48 and seal face ring 44. In one embodiment of the present invention, seal face ring 44 is formed from a ceramic material (e.g., Silicon Nitride, Silicon Carbide or Aluminum oxide, that can be hot pressed or sintered, and may include additive in order to modify the physical properties of the ceramic) that is designed to provide low mechanical friction to a cooperating sealing face member engaged therewith (discussed below) while providing enough structural stability to seal the assembly, however, it is to be appreciated that seal face ring 44 may be formed from any suitable material without varying from the scope of the present invention.

Runner assembly 40 further includes an inner O-ring 52 disposed in a radially inward facing groove 53 defined in an inner surface of support member 48 such that inner O-ring 52 interfaces with both support member 48 and pump shaft 34 forming a static sealed joint between the high pressure and low pressure sides of sealing arrangement 38. Runner assembly 40 also includes an outer O-ring 54 positioned in an upward and radially outward facing notch 55 defined in a top portion of support member 48. Outer O-ring 54 forms a static sealed joint between the top of support member 48 and the bottom of seal face ring 44 between the high and low pressure sides of sealing arrangement 38. The radial position of outer O-ring 54 is selected such that the difference in force resulting from the hydrostatic pressure on the film surface of seal face ring 44 is greater than the force resulting from the hydrostatic pressure on the bottom surface of seal face ring 44. The net force causes seal face ring 44 to be firmly held against support member 48. Additionally, the axial compression of outer O-ring 54 between seal face ring 44 and support member 48 is designed to compensate most of the hydrostatic preload in order to decouple any waviness induced by the installation on the shaft shoulder.

Support shroud 46 is fixed to support member 48 with mechanical fasteners 49. Support shroud 46 serves to: provide radial centering to seal face ring 44, hold seal face ring 44 onto support member 48 for assembly and start-up, provide initial compression of outer O-ring 54, and provide a thermal barrier to protect the outside surfaces of seal face ring 44 from rapid changes in temperature of the process fluid and the consequential thermo-elastic distortion that may alter the seal geometry and leakage rate. In addition, support shroud 46 is designed to prevent foreign material from migrating to the back face of seal face ring 44 and disturbing the contact surfaces between seal face ring 44 and support member 48. Support shroud 46 is sized such that, during normal operation, a small (e.g., approximately 0.004″-0.005″) axial gap exists between shoulder 45 of seal face ring 44 and overhang 47 of support shroud 46.

Continuing to refer to FIGS. 3 and 4, seal assembly 42 includes an upper annular ring sealing face member 56 mounted in an upper annular ring base or support member 60 which, in turn, is keyed to an upper housing 61 and thus to seal housing 32 (which is bolted to upper housing 61), by a number of anti-rotation pins 62 so as to prevent rotational movement of seal assembly 42 relative to the seal housing 32 but allow translatory movement of seal assembly 42 along pump shaft 34 toward and away from runner assembly 40. A spring 63 is provided around pin 62 so as to bias seal assembly 42 toward runner assembly 40, and thus sealing face member 56 into contact with seal face ring 44. Spring 63 provides the initial loading to put the contacting faces of sealing face member 56 and seal face ring 44 in contact prior to pressurization. It is to be appreciated that any suitable biasing member in place of, or in addition to may be employed to bias seal assembly 42 toward runner assembly 40 without varying from the scope of the present invention.

Hydrostatic loading at the balance diameter of seal assembly 42 is ensured by a dynamic channel seal 69 and an O-ring 70 seated within a radially inward facing annular groove 72 which circumscribes the inner diameter of an upper portion of upper support member 60. Channel seal 69 is a thermoplastic cap designed to seal against and slide along a cylindrical wear sleeve 74 which forms part of seal housing 32 of coolant pump 14 in order for seal assembly 42 to adjust to pump shaft motion and pressure changes. O-ring 70 serves to provide preload (radially) to channel seal 69 and also can serve as a backup seal in case channel seal 69 fails. The seal provided by channel seal 69 not only prevents leakage, but also serves to determine the magnitude of the seating force.

The shape of seal face ring 44 is selected to provide the desired net moment resulting from a pressure increase in case of an upset condition leading to sealing arrangement 38 being used as a high pressure seal. This shape allows for operation over a large pressure range with controlled volumetric leakage and wear. Seal face ring 44 has a top flat surface with a limited range of surface finish to provide adequate wear and lubrication during operation at low pressures. However, alternate embodiments of the invention can be realized by utilizing a stepped surface, a radial tapered surfaced or non-uniform surface texturing in lieu of or in combination with a flat film surface. The designer can tune the shape and surface finish of seal face ring 44 to achieve a seal leakage rate, pressure-flow relationship, or wear rate suitable for the particular application.

Sealing arrangement 38 departs in the way the seal faces are supported and designed to provide low friction and adaptable behavior to surrounding changes in temperature and pressures. This allows the new arrangement to be able to operate in both low pressure/mixed lubrication conditions and high pressure/film riding conditions. In addition, the improved runner assembly 40 represents a departure from conventional arrangements by replacing seal materials and components. Conventional arrangements use several O-rings and vent holes between the support base and the shaft to provide rotation of the assembly in case of pressure changes. Additionally, the conventional arrangements employ a hard face coating directly applied on a stainless steel support base pocket. The coating is constrained within the bounds of the support base pocket which creates stresses due to the differential thermal expansion of both materials. This bounded arrangement is problematic as it creates stresses in the seal face that leads to a non-axisymmetric wave pattern. This change in seal face geometry then creates unstable seal leakage and excessive wear to the mating carbon graphite ring, in addition to potential failures of the coating that could render the seal inoperative.

In contrast, the improved design described herein provides an engineered seal face design that allows for controlled deflection and rotation with pressure to provide a controlled leakage seal in low pressure/mixed lubrication conditions and in high pressure/film riding conditions. This is achieved by precisely controlling the contacts and forces on the seal face, in particular the contacts and forces between seal face ring 44 and support member 48 in order to control the reaction point between the faces during transition from low pressure to high pressure and from high pressure to low pressure, thus providing a controlled rotation of the seal face and therefore providing the desired pressure profile leading to stable performances. The improved design eliminates the coating as a seal interface and replaces it with ceramic seal face ring 44. Ceramic seal face ring 44 is free to radially move on support member 48, eliminating any additional stress or deflection during changes of temperature from the surrounding fluid or from the heat generated at the surface of the seal. This controlled deformation ensures a better and more stable operating seal. Seal face ring 44 is maintained in axial position by support shroud 46 that is designed to prevent separation of seal face ring 44 from outer O-ring 54 to provide positive hydrostatic seating in all conditions. The seal face being not bounded to the seal support base, the deflections from the waviness of the shaft shoulder or sleeves comprised in the complete pump seal assembly are then not transferred to the seal face.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A runner assembly for mounting to, and rotating with, a pump shaft of a pump, the runner assembly comprising:
a support member structured to be fixed to the pump shaft;
a seal face ring positioned on, and mounted to the support member by a support shroud coupled to the support member; and
an outer O-ring positioned in an upward and radially outward facing notch defined in a top portion of the support member, the outer O-ring forming a static sealed joint between the top of the support member and the bottom of the seal face ring.

2. The runner assembly of claim 1, wherein the seal face ring is formed from a ceramic material.

3. The runner assembly of claim 1, wherein the seal face ring comprises a shoulder formed in a radially outward portion thereof, wherein the support shroud comprises an overhang formed in a radially inward portion thereof, and wherein the shoulder and the overhang radially overlap.

4. The runner assembly of claim 1, wherein the seal face ring is fixed relative to the support member via a number of drive pins such that there is no relative rotation between the pump shaft, the support member, and the seal face ring.

5. The runner assembly of claim 1, further comprising a number of anti-rotation pins for fixing the support member to the pump shaft.

6. A sealing arrangement for use with a pump having a pump housing which terminates at one end in a seal housing and a pump shaft, the sealing arrangement comprising:
a lower annular runner assembly structured to be mounted to the pump shaft for rotation therewith, the runner assembly comprising:
a support member structured to be fixed to the pump shaft,
a seal face ring positioned on, and mounted to the support member by a support shroud coupled to the support member, and
an outer O-ring positioned in an upward and radially outward facing notch defined in a top portion of the support member, the outer O-ring forming a static sealed joint between the top of the support member and the bottom of the seal face ring, and
an upper annular seal assembly structured to be stationarily mounted within the seal housing, the seal assembly comprising:
an upper annular ring sealing face member positioned for sealing with the seal face ring, the sealing face member mounted in an upper annular support member structured to be coupled to the seal housing via a number of anti-rotation pins so as to prevent rotational movement of the assembly relative to the seal housing but allow translatory movement of the seal assembly along the pump shaft toward and away from the runner assembly.

7. The sealing arrangement of claim 6, wherein the seal face ring is formed from a ceramic material.

8. The sealing arrangement of claim 6, wherein the seal face ring comprises a shoulder formed in a radially outward portion thereof, wherein the support shroud comprises an overhang formed in a radially inward portion thereof, and wherein the shoulder and the overhang radially overlap.

9. The sealing arrangement of claim 6, wherein the seal face ring is fixed relative to the support member via a number of drive pins such that there is no relative rotation between the pump shaft, the support member, and the seal face ring.

10. A pump comprising:
a pump housing which terminates at one end in a seal housing;
a pump shaft extending centrally within the pump housing and being sealingly and rotatably mounted within the seal housing; and
a sealing arrangement provided about the pump shaft and within the pump housing, the sealing arrangement comprising:
a lower annular runner assembly mounted to the pump shaft for rotation therewith, the runner assembly comprising:
a support member fixed to the pump shaft,
a seal face ring positioned on, and mounted to the support member by a support shroud coupled to the support member, and
an outer O-ring positioned in an upward and radially outward facing notch defined in a top portion of the support member, the outer O-ring forming a static sealed joint between the top of the support member and the bottom of the seal face ring, and
an upper annular seal assembly stationarily mounted within the seal housing, the seal assembly comprising an upper annular ring sealing face member positioned for sealing with the seal face ring, the sealing face member mounted in an upper annular support member coupled to the seal housing via a number of anti-rotation pins so as to prevent rotational movement of the assembly relative to the seal housing but allow translatory movement of the seal assembly along the pump shaft toward and away from the runner assembly.

11. The pump of claim 10, wherein the seal face ring is formed from a ceramic material.

12. The pump of claim 10, wherein the seal face ring comprises a shoulder formed in a radially outward portion thereof, wherein the support shroud comprises an overhang formed in a radially inward portion thereof, and wherein the shoulder and the overhang radially overlap.

13. The pump of claim 10, wherein the seal face ring is fixed relative to the support member via a number of drive pins such that there is no relative rotation between the pump shaft, the support member, and the seal face ring.

14. The pump of claim 10, wherein a first end of the pump shaft is connected to an impeller and an opposite second end is connected to an electric motor, and wherein the impeller is positioned within an interior of the pump housing.

15. The pump of claim 10, wherein the support member is fixed to the pump shaft via a number of anti-rotation pins.

16. The pump of claim 10, further comprising a biasing member positioned to bias the seal assembly toward the runner assembly, and thus the sealing face member into contact with the seal face ring.
